(19) United States
(12) Patent Application Publication
(10) Pub. No.: US 2009/0248642 A1
(43) Pub. Date: Oct. 1, 2009

(54) SYSTEM, METHOD, AND COMPUTER PROGRAM PRODUCT FOR ORGANIZING AND ACCESSING WEBSITES

(75) Inventors: Sergey Gurin, Hollywood, FL (US); Vyacheslav Reshetnyak, Hollywood, FL (US); Ivan Onuchin, Hollywood, FL (US)

Correspondence Address: HOWARD & HOWARD ATTORNEYS PLLC, 450 West Fourth Street, Royal Oak, MI, 48067, US

(73) Assignee: Helpful Technologies, Inc., Fort Lauderdale, FL (US)

(21) Appl. No.: 12/410,129

(22) Filed: Mar. 24, 2009

Related U.S. Application Data
(60) Provisional application No. 61/039,130, filed on Mar. 25, 2008.

(51) Int. Cl. G06F 17/00; G06F 17/30

(52) U.S. Cl. 707/3; 715/206; 715/810; 707/E17.014

(57) ABSTRACT

A system includes server and client computers communicating over a network. The server includes a database of websites. A user logs into one of the client computers and is presented with a stand-alone application for organizing and accessing websites that is separate from a web-browser. The application presents the alphabet to the user and allows the user to select one or more letters of the alphabet. When a letter is selected, the application presents a list of websites to the user and allows the user to select a website. The web address of the selected website is then sent to the web-browser for display of the webpage. The application also presents advertisements to the user that are not blocked by ad blocking programs.

### CROSS REFERENCE TO RELATED APPLICATION

This application claims the benefit of provisional patent application No. 61/039,130, filed Mar. 25, 2008, which is hereby incorporated by reference.

### BACKGROUND OF THE INVENTION

1. Field of the Invention

The invention relates to systems, methods, and computer program products for organizing and accessing websites.

2. Description of the Related Art

Web browsing applications, such as Internet Explorer or Mozilla Firefox, are the predominant means for accessing information on a network, such as the Internet. These web browsing applications typically allow a user to access websites by typing in a website address, i.e., its URL, by using a web search engine, or by selecting from a list of “favorites” or “bookmarks” that were previously saved by the user.

Unfortunately, many new users are not familiar with, or find it difficult to enter or remember, the website addresses needed to first access a website. This difficulty may stem from a general lack of computer “literacy” or a physical or mental impairment of the user. Furthermore, the generation of a “favorites” or “bookmark” list, i.e., links, is generally cumbersome. Moreover, sorting and organizing these links is often done in a haphazard fashion without any logical way to retrieve the links.

In addition, website content is often dependent on the sale of advertisements that are displayed to the user. However, many applications are in existence to block the display of advertisements to web browsing applications. Thus, quality website content is often stunted by the lack of ad revenue.

The present invention is aimed at solving these and other shortcomings of the related art.

### SUMMARY OF THE INVENTION AND ADVANTAGES

The invention provides a computer-implemented method of organizing and accessing websites that are accessible with a web browser application running on a client computer. Each website is identified with a website address and a website title. The method includes the step of providing a browsing interface application running on the client computer. The browsing interface application runs separately from the web browser application. The method also includes the step of maintaining a database of websites. Letters of the alphabet are displayed in the browsing interface application. These letters are selectable by a user. The method further includes the step of receiving a letter of the alphabet selected by the user via the browsing interface application. A list of websites from the database of websites associated with the letter of the alphabet selected by the user are displayed in the browsing interface application. The displayed websites are selectable by the user. The method also includes receiving a website selected by the user via the browsing interface application. In response to receiving the website selected by the user, the browser application is directed to the website address associated with the website selected by the user.

The invention also provides a computer program product for organizing and accessing websites that are accessible with a separate web browser application. The computer program product includes computer readable program code means for maintaining a database of websites wherein each website is associated with a website address and a website title. The computer readable program code means also display letters of the alphabet independently from the web browser application. The displayed letters are selectable by a user. The computer readable program code means receives a letter of the alphabet selected by the user. The computer readable program code means for displaying a list of website titles from the database of websites associated with the letter of the alphabet selected by the user. The displayed website titles are selectable by the user. The computer readable program code means allow for receiving a website selected by the user. The computer readable program code means direct the web browser application to the website address associated with the website title selected by the user.

The invention further provides a system for organizing and accessing websites. The system includes a server computer maintaining a database of websites. Each website is associated with a website address and a website title. The system also includes a client computer having a display and an input mechanism. The client computer is in communication with the server computer. The client computer is also capable of running a web browser application and a browsing interface application. The browsing interface application displays letters of the alphabet that are selectable by a user, receives a letter of the alphabet selected by the user, retrieves a list of website titles from the database that are associated with the letter selected by the user, displays the list of website titles from the database, receives the website title selected by the user, and directs the web browser application to the website address associated with the website title selected by the user.

By utilizing the method, system, and computer program product of the present invention, a user may browse the Internet without having to type in the address of a webpage and in a logical, easy-to-understand manner. This is advantageous for many individuals who are not comfortable typing in web addresses or using a computer in general. Furthermore, by the browsing interface application being separate from the web browser application, the present invention also allows a user to access a destination website without opening the web browser application or navigating to a homepage. Thus, users are able to navigate through the Internet easier and faster than with solely the web browser application.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a schematic diagram of a system of the present invention showing a server computer in communication with multiple client computers;

FIG. 2 is a view of a display of one of the client computers showing one embodiment of a user interface of a browsing interface application;

FIG. 3 is a view of a sign-in dialog of the user interface;

FIG. 4 is a view of a list of websites provided by the user interface;

FIG. 5 is a view of a list of specialized websites associated with one of the list of websites;

FIG. 6 is a view of a another embodiment of the user interface;

FIG. 7 is a view of a add link dialog of the user interface; and

FIG. 8 is a view of a drop-down menu of advertisements of the user interface.

### DETAILED DESCRIPTION OF THE INVENTION

Referring to the Figures, wherein like numerals indicate like parts throughout the several views, a system 10, method, and computer program product are described herein.

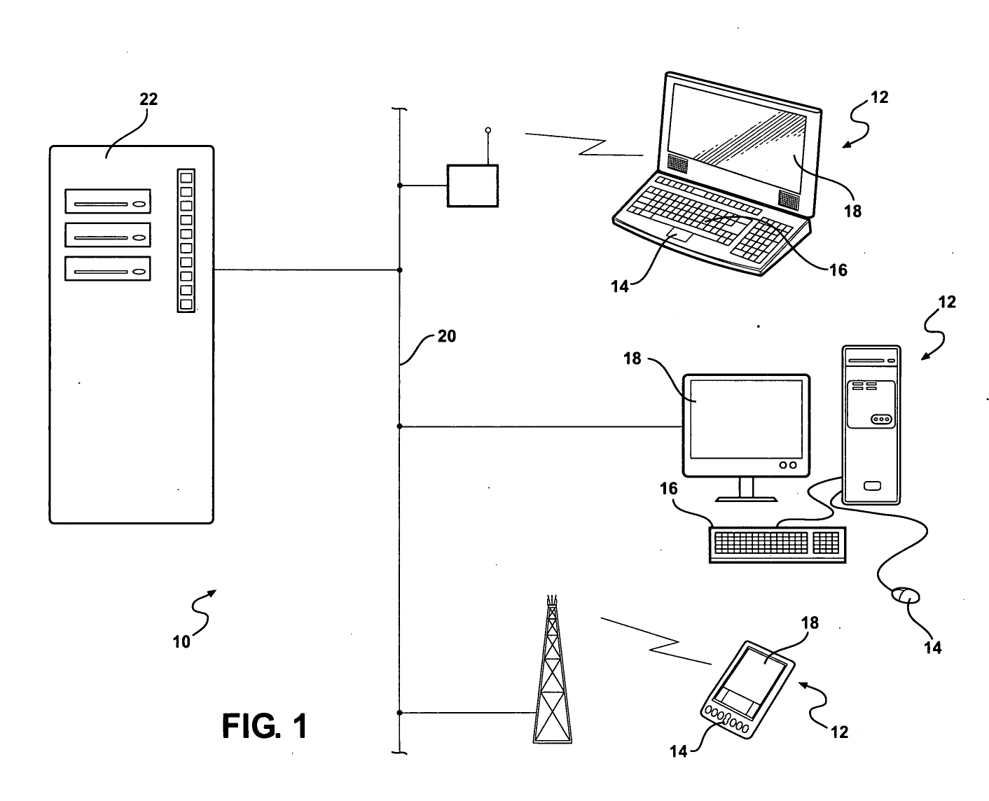

Referring to FIG. 1, the system 10 includes at least one client computer 12. The client computer 12 may be implemented as a standard desktop, laptop, notebook-type device running an operating system such as, but not limited to, Microsoft Windows, Apple Mac OS, Linux, UNIX, FreeBSD, and Solaris. Other suitable operating systems are well known to those skilled in the art. The client computer 12 may also be implemented as a handheld device, such as, but not limited to, a personal digital assistant (PDA), a mobile telephone, and/or a smartphone running an operating system such as, but not limited to, PalmOS, Java, or Blackberry OS. Therefore, with the inclusion of such portable devices, the term “client computer” is not limited solely to the standard “desktop” and “laptop” personal computers. Moreover, those skilled in the art realize other suitable devices for implementing the client computer 12 as consistent with the description herein.

The client computer 12 preferably includes a pointing device 14, a keyboard 16, and a display 18. The pointing device 14 enables a user to interact with the client computer 12 and make selections without the need for the keyboard 16. The pointing device 14 may be a mouse, a trackball, a touchpad, a touchscreen interface, an optical pointer, or other suitable device known by those skilled in the art. In alternate embodiments, the client computer 12 may be implemented without the keyboard 16 or without the pointing device 14.

The client computer 12 is preferably in communication with a computerized network 20. The computerized network 20 is preferably the global system of networks known as the Internet, but other networks may also be suitable. The communications between the client computer 12 may be accomplished by a hardwired network, a wireless network, and/or other networking techniques, as readily understood by those skilled in the art.

In the preferred embodiment, the system 10 also includes a server computer 22 in communication with the client computer 12 via the network 20. The server computer 22 is preferably disposed remotely from the client computer 12. Furthermore, multiple server computers 22 may also be utilized. Functionality of the server computer 22 will be described in detail below.

The client computer 12 is capable of running a web browser application (not shown). Numerous suitable web browser applications are available, including, but not limited to, Microsoft Internet Explorer, Mozilla Firefox, Apple Safari, Google Chrome, and Opera. The web browser application allows access and interaction with the World Wide Web (WWW). The WWW is a system of interlinked hypertext documents, i.e., websites, which are accessible via the Internet.

The client computer 12 is also capable of running a browsing interface application (not shown). The browsing interface application allows for organization and access of websites. In the preferred embodiment, the browsing interface application is a computer program product that runs separately from the web browser application. However, in alternative embodiments, the browsing interface application runs within one or more of the web browser applications on the client computer 12.

The browsing interface application maintains a database (not shown) of websites. The database of websites is preferably stored on both the client computer 12 and the server computer 22. Thus, the client computer 12 and the server computer 22 each backup the database of websites. However, the browsing interface application is also operable with the database of websites stored on only one of the client computer 12 and the server computer 22.

Each website stored in the database of websites is preferably identified with a website address and a website title, i.e., the website address and website title are stored in the database. The website address is preferably the uniform resource locator (URL) that is used by domain name servers (DNS) to locate an internet protocol (IP) address for a web server. For example, the website address for the popular search engine Google is http://www.google.com while the website address for Michigan State University is http://www.msu.edu. Alternatively, the website address may be the IP address for the web server. The website title is used to describe the website. The website title may be supplied by the website itself or by a user of the browsing interface application.

Other information regarding each website may be stored in the database. This information may include, but is not limited to, a description of the website, a categorical classification of the website, the number of times the website has been accessed by the user, other statistical information regarding the website, and a search query formulator for the website for those website which use a search engine.

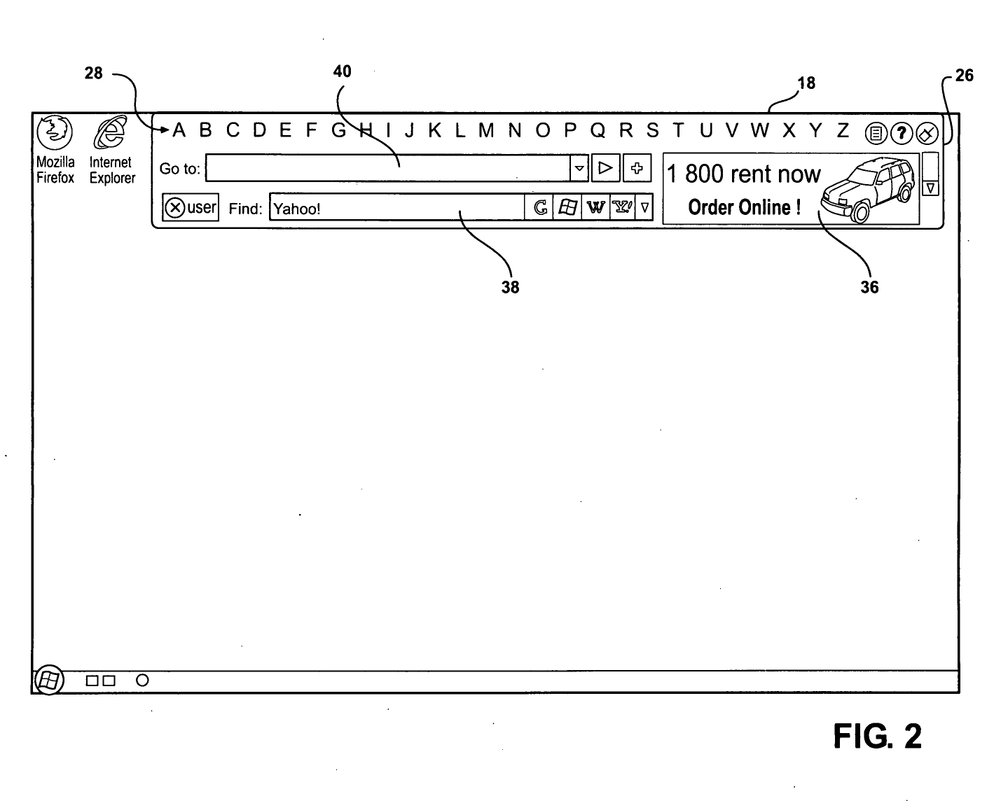

With reference to FIG. 2, the browsing interface application includes a user interface 26 that is displayed on the display 18 of the client computer 12. The user interface 26 is the text and graphics based presentation of the browsing interface application to the user.

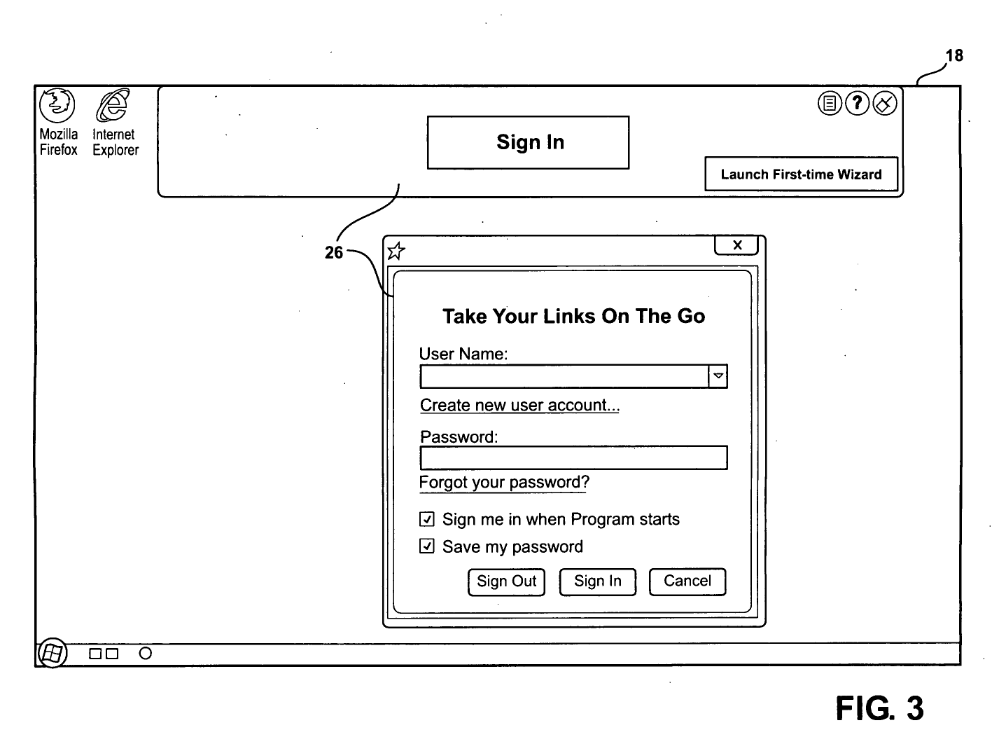

In the preferred embodiment, operation of the user interface 26 begins with the user logging in by typing a username and password, as shown in FIG. 3. The server computer 22 validates the username and password entered by the user. Thereafter, the server computer 24 synchronizes the database of websites between the client computer 12 and the server computer 22, as shown in FIG. 1. As such, the user can access the database of websites from one or more other client computers 12 (e.g., a home computer and work computer) that run the browsing interface application. However, in alternative embodiments, the browsing interface application functions without a login by the user.

The browsing interface application displays the letters of the alphabet 28. That is, the user interface 26 displays the letters of the alphabet 28 to the user, as shown in FIG. 2. In the preferred embodiment, each and every letter of the alphabet 28 is displayed individually and separately. However, in alternative embodiments, certain letters of the alphabet may be grouped together (e.g., A-F, G-K, L-P, Q-U, V-Z). Furthermore, the illustrated embodiment shows the 26-letter alphabet of the English language with the letters progressing from A to Z. However, in alternative embodiments, the letters of non-English alphabets may be displayed or the order of the alphabet may be different.

The letters of the alphabet 28 are selectable by the user by the pointing device 14. For example, when implemented with a mouse, the pointing device 14 may be used to “point-and-click” on the desired letter of the alphabet 28. Alternatively, the letters of the alphabet may also be selectable by the user via the keyboard 16. The browsing interface application receives the letter (or letters) of the alphabet selected by the user, regardless of the input method, i.e., pointing device 16 or keyboard 18.

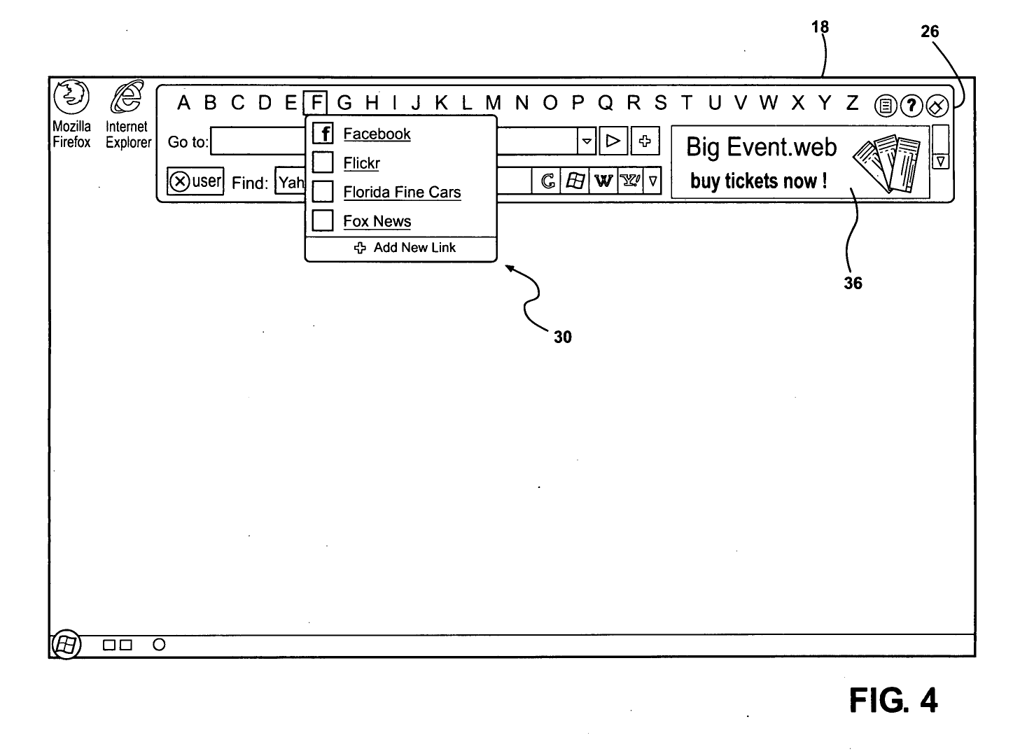

In response to the selection of the letter, the browsing interface application displays a list of websites 30 from the database of websites associated with the letter of the alphabet 28 selected by the user, as shown in FIG. 4. For example, if the letter “A” was selected, the browsing interface application may display one or more websites that begin with the letter “A”, such as amazon.com, ask.com, Apple Computer, about.com, or AT&T. Each of the displayed websites is selectable by the user, preferably by using the pointing device 16. Accordingly, the browsing interface application receives the website selected by the user.

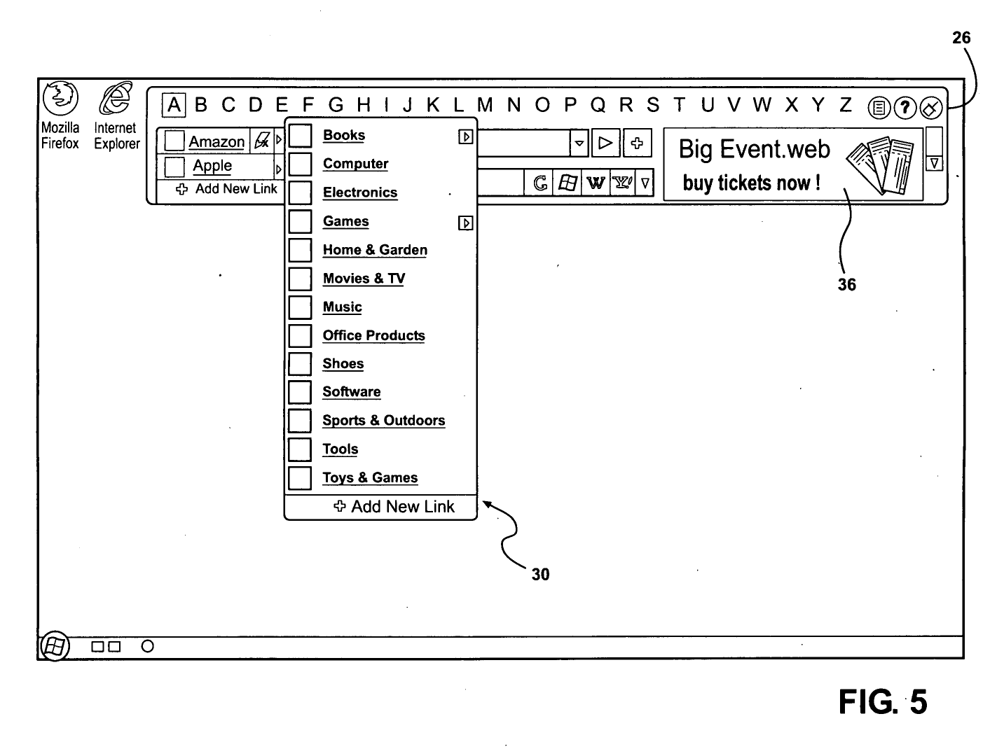

One or more of the displayed websites may be broken down into specialized websites 30. For example, as shown in FIG. 5, Amazon.com, the on-line retailer, may be broken down into categories such as books, music, and electronics, wherein each category is associated with its own website 30. The specialized websites 30 are then displayed as a list and the user is then able to select one.

Additionally or alternatively, categories of websites may be displayed in response to the selection of a letter. For example, when the letter “A” is selected, the categories of auto warrant, accessories, and/or audio books may be displayed.

In response to the selection of the website, the browsing interface application communicates with the browser application and directs the browser application to the website address associated with the website selected by the user. Accordingly, the browser application will display the website to the user.

The browsing interface application of the present invention also enables the user to easily access and utilizes browsing tools, e.g., bookmarks, while working with other applications running on the client computer.

As such, the user may identify the Internet destinations without even starting the browser application. Said another way, the browsing interface application may be utilized as the initial starting point to web browsing. Importantly, the user may browse the Internet without having to type in the address of a webpage or use the keyboard 18 whatsoever. This is advantageous for many individuals who are not comfortable typing in web addresses or using a computer in general.

Several different techniques may be utilized to generate the database of websites. Preferably, when the browsing interface application is used for the first time, the database is populated with a pre-selected number of websites. The selection of these websites is preferably based on research and rankings of Internet usage, such as that performed by Alexa Internet, Inc.

The database of websites is customizable by the user. That is, the user can add or subtract websites due to their preferences. As eluded to above, each website in the database includes a website address and a website title. The website title may be the title received from the website, or one supplied by the user.

The letter of the alphabet associated with each website may be the first letter of the title of the website. For instance, the letter “C” may be associated with Craiglist.org. However, the letter of the alphabet associated with each website may not necessarily be the first letter of the title of the website. For instance, the website for the National Weather Service may be associated with “W” for “weather”.

The database of websites may also include a plurality of categories. Each website stored in the database may be associated with one or more of the categories, regardless of their alphabetic initial. For example, one category might be “shopping” and be associated with online retailers Amazon, Ebay, and Zappos. Another category might be “search engines” and be associated with the websites for Google and Yahoo.

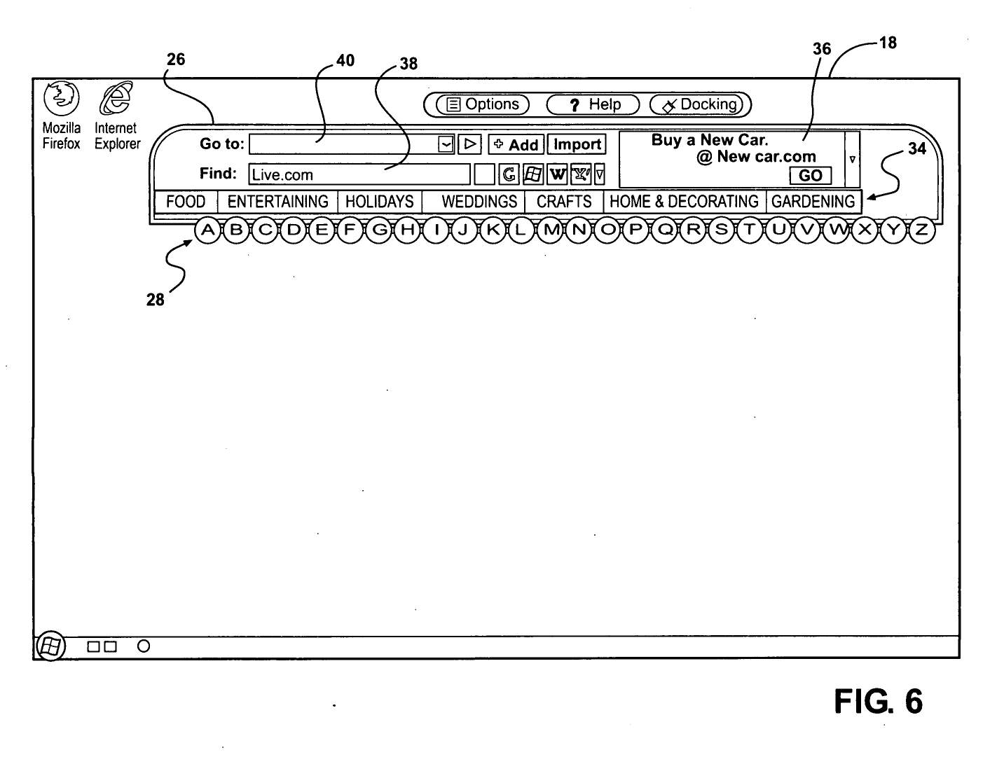

In one embodiment of the present invention, as shown in FIG. 6, the user interface may display the plurality of categories 34. These categories 34 are selectable by the user. Preferably, the user may point-and-click on the desired category 34 to make a selection. Accordingly, the browsing interface application then receives the selection of the user. The categories 34 are preferably separate from the letters of the alphabet, such that the user has multiple avenues for finding a desired website, either: (a) with the letters of the alphabet or (b) with the categories.

In response to the selection of the desired category 34, the browsing interface application displays a list of websites from the database of websites associated with the category 34 selected by the user. These websites are the selectable by the user and communicated to the web browser application for display to the user.

The browsing interface application may also convey one or more advertisements 36 to the user. Specifically, the user interface 22 displays the advertisements 36 to the user. As the preferred embodiment of the browsing interface application is a stand-alone application, i.e., separate from the web browser, advertisers are able to reach their target audience without going through the web browser. As such, advertising blocking programs that are often integrated with the web browser application are not able to block the advertisements from reaching the user when using the browsing interface application of the present invention.

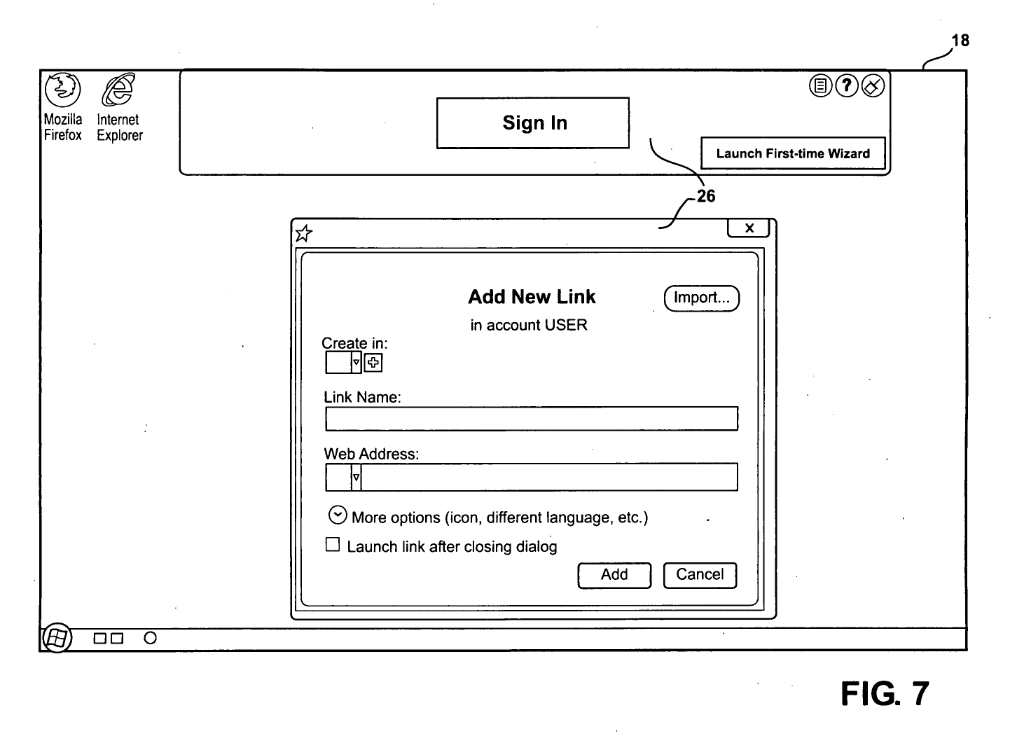

Preferably, the browsing interface application can display multiple advertisements 36 to the user. Furthermore, more than one advertisement 36 may be displayed at one time. However, as shown in FIGS. 2-7, typically only one advertisement 36 is displayed at a time. This advertisement 36 may change based on the search habits of the user and/or by preference of the advertiser. For instance, if the user has selected the website for a particular on-line book seller, the advertisement 36 for a rival on-line book seller may be presented to the user. The advertisement 36 may also be changed randomly.

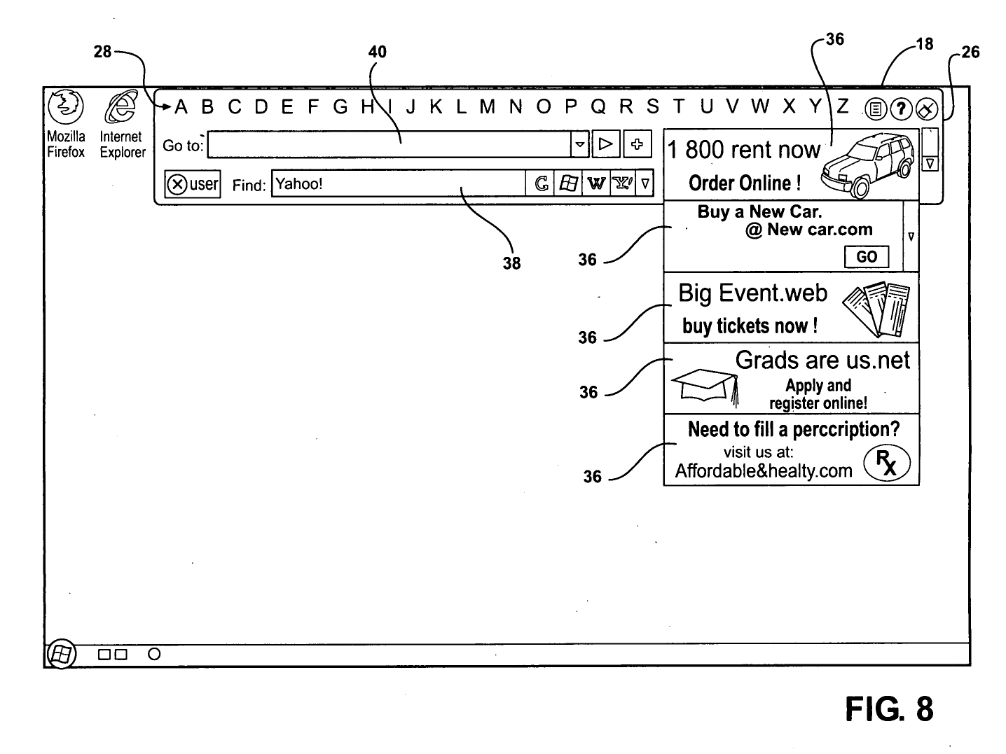

The browsing interface application also allows the user to retrieve advertisements 36 that are no longer displayed on the user interface 26. As shown in FIG. 8, the user may select a drop-down history of advertisements 36 that have previously been displayed.

The advertisements 36 may be selected by the user, preferably using the pointing device 14. Once selected, the browsing interface application communicates a website IP address and/or URL associated with the advertisement 36 to the browser application. The browser application is then directed to the website of the advertisement.

The user interface 26 of the browsing interface application may also present a search field 38 to the user. The search field 38 allows the user to input search queries in order to find a webpage associated with keywords of those search queries. The search queries are received by the browsing interface application and communicated to a search engine, such as those provided by Google, Yahoo!, and others as is known to those skilled in the art. In one embodiment, the results of the search are returned from the search engine and displayed by the web browser application.

The browsing interface application also enables users to customize a set of search engines based on their preferences. A customize set of search engines is easily accessible via the user interface 26 while working with any program running on the client computer 12.

The user interface 26 of the browsing interface application may also present a URL address field 40 to the user. A website address may be entered into the address field 40 by the user. The browsing interface application then communicates the website address to the web browser application for display of the website to the user. The user interface 26 of the browsing interface application may be configured with various “skins”. These skins may vary based on the selection of the user and/or a system administrator. A skin may contain one or more selectable regions which, when selected, direct the web browser application to a specified URL. For example, if the browsing interface application is provided by a business, the logo of the business may be featured on the user interface 26 as part of the skin. When the logo is selected, the web browser application is directed to the home page of that business. In fact, the entire skin may be an advertisement for the business, in addition to, or in lieu of, the advertisements described previously.

The user interface 26 may also display other embodiments, such as, but not limited to, numerical embodiments, sets of numbers, folders, shortcut labels, and filters. These additional embodiments may be created by the user and/or a system administrator.

The present invention has been described herein in an illustrative manner, and it is to be understood that the terminology which has been used is intended to be in the nature of words of description rather than of limitation. Obviously, many modifications and variations of the invention are possible in light of the above teachings. The invention may be practiced otherwise than as specifically described within the scope of the appended claims.

What is claimed is:

1. A computer-implemented method of organizing and accessing websites that are accessible with a web browser application running on a client computer, wherein each website is identified with a website address and a website title, said method comprising the steps of:
providing a browsing interface application running on the client computer separately from the web browser application;
maintaining a database of websites;
displaying letters of the alphabet in the browsing interface application wherein the letters are selectable by a user;
receiving a letter of the alphabet selected by the user via the browsing interface application;
displaying a list of websites from the database of websites associated with the letter of the alphabet selected by the user in the browsing interface application wherein the displayed websites are selectable by the user;
receiving a website selected by the user via the browsing interface application; and
directing the web browser application to the website address associated with the website selected by the user.

2. A method as set forth in claim 1 further comprising the step of storing a website to the lists of websites.

3. A method as set forth in claim 2 further comprising the step of associating the website with one of the letters of the alphabet.

4. A method as set forth in claim 3 wherein the letter of the alphabet associated with the website is automatically assigned as the first letter of the title of the website.

5. A method as set forth in claim 3 wherein the letter of the alphabet associated with the website is manually chosen by the user.

6. A method as set forth in claim 1 wherein said step of displaying letters of the alphabet is further defined as displaying all letters of the alphabet in the browsing interface application wherein each letter is selectable by a user.

7. A method as set forth in claim 1 further comprising the step of storing the list of websites on a server computer remote from the client computer.

8. A method as set forth in claim 1 further comprising the step of displaying an advertisement via the browsing interface application.

9. A method as set forth in claim 1 further comprising the step of prioritizing the list of websites.

10. A method as set forth in claim 1 wherein the selection of the letter is performed using a pointing device.

11. A method as set forth in claim 1 further comprising the steps of presenting a search field dialog for receiving search queries from the user and communicating the search queries to a search engine such that the result of a search by the search engine is displayed in the web browser application.

12. A computer program product for organizing and accessing websites that are accessible with a separate web browser application, said computer program product comprising:
computer readable program code means for maintaining a database of websites wherein each website is associated with a website address and a website title;
computer readable program code means for displaying letters of the alphabet independently from the web browser application, wherein the letters are selectable by a user;
computer readable program code means for receiving a letter of the alphabet selected by the user;
computer readable program code means for displaying a list of website titles from the database of websites associated with the letter of the alphabet selected by the user, wherein the displayed website titles are selectable by the user;
computer readable program code means for receiving a website title selected by the user; and
computer readable program code means for directing the web browser application to the website address associated with the website selected by the user.

13. A computer readable program product as set forth in claim 12 further comprising computer readable program code means for displaying an advertisement separate from the web browser application.

14. A system for organizing and accessing websites, said system comprising:
a server computer maintaining a database of websites wherein each website is associated with a website address and a website title;
a client computer having a display and an input mechanism and in communication with said server computer;
said client computer capable of running a web browser application and a browsing interface application;
said browsing interface application displaying letters of the alphabet that are selectable by a user, receiving a letter of the alphabet selected by the user, retrieving a list of website titles from said database that are associated with the letter selected by the user, displaying the list of website titles from said database, receiving the website title selected by the user, and directing said web browser application to the website address associated with the website title selected by the user.

15. A system as set forth in claim 14 further comprising a computerized network connected to said server computer and said client computer for facilitating communications between said server computer and said client computer.

16. A system as set forth in claim 15 wherein said server computer is disposed remote from said client computer.

17. A system as set forth in claim 14 wherein said client computer is further defined as a first client computer and a second client computer.

18. A system as set forth in claim 17 wherein the website titles displayed and selectable on the first client computer are the same as the website titles displayed and selectable on the second client computer.

19. A system as set froth in claim 14 wherein said browsing interface application displays an advertisement in the browsing interface application separate from the web browser application.
